(19) United States
(12) Patent Application Publication
(10) Pub. No.: US 2010/0264180 A1
(43) Pub. Date: Oct. 21, 2010

(54) Collapsible Tool/Utility Box

(76) Inventor: Nii-Akwei Allotey, Denver, CO (US)

Correspondence Address: MARIAN J. FURST, ATTORNEY AT LAW, 4956 W.6200 S., #315, KEARNS, UT, 84118, US

(21) Appl. No.: 12/347,750

(22) Filed: Dec. 31, 2008

(51) Int. Cl. B60R 9/00

(52) U.S. Cl. 224/404

(57) ABSTRACT

Collapsible or foldable tool/utility box that can be folded into a compact configuration when not in use or unfolded to form a container for tools or other objects. The box is joined to a portion of the floor or sidewall of a vehicle and is stowed in a compartment underneath the floor or in the sidewall when not in use.

### FIELD OF THE INVENTION

The present invention relates generally to tool or utility storage boxes, and more particularly to collapsible tool or utility storage boxes that integrated into the floor or sidewall of a vehicle bed or cargo area.

### BACKGROUND OF THE INVENTION

Often, it is desirable to carry items such as tools or packages in the back of a pickup truck or sport utility vehicle or in the trunk of car. If the items are not secured or restrained in place, they can slide around while the vehicle is in motion, causing noise and possibly damaging the items and/or the vehicle. If smaller items are carried in the uncovered back of a pickup truck, it is also desirable that they are placed inside a lockable container, particularly if the items are valuable or subject to damage from wind and weather. Ideally, the container is itself anchored to the bed or sides of the cargo area, so the container cannot be easily removed, such as by a potential thief.

Tool boxes are available that can be installed in the beds of pickup trucks. In general, these boxes fit into the front portion of the pickup truck cargo area, in front of the rear wheel wells. Usually, these tool boxes are permanently installed, with a resulting loss of space for other cargo. A collapsible tool or utility storage box was described in copending patent application Ser. No. 11/137,887, invented by Nii-Akwei Allotey, filed on May 26, 2005, entitled “Collapsible Tool/Utility Box,” which is incorporated herein by reference in its entirety. However, it may be desirable to use the vehicle for other purposes where the space occupied by the container is needed. Thus, there is a need for a tool or utility storage box for transporting tools and/or other items in the back of a pickup truck or sport utility vehicle or in the trunk of a car, that can be easily set up and collapsed for compact storage, as needed, yet that is permanently installed into the vehicle and does not occupy significant cargo space when it is collapsed.

### SUMMARY OF THE INVENTION

To achieve the foregoing and other objects and in accordance with the purpose of the present invention broadly described herein, one embodiment of this invention comprises a collapsible storage box. The box comprises a housing having a wall and a lower edge, with two side extensions and a top extension joined to and extending from the wall. It also comprises two hinged, foldable side walls with hinges joining each of the side walls to the side edges of the housing. The side walls are foldable and unfoldable relative to each other and relative to the housing by rotation at the hinges. In addition, the box has a rear wall hingedly joined to the side walls and a cover hingedly joined to the top extension of the housing, with the cover pivotable between a collapsed configuration with the cover adjacent to and substantially parallel to the housing wall and an open configuration providing access to an interior space within the box. The box is adjustable between a collapsed configuration with the bottom, the side walls, and the cover pivoted into positions substantially parallel to the planar wall of the housing and an uncollapsed configuration with the bottom and the top substantially perpendicular to the housing wall and with the side walls substantially perpendicular to the bottom and the cover. The housing is integral with the floor or a sidewall of a vehicle cargo area. The vehicle cargo area may be in a vehicle selected from pickup trucks, sports utility vehicles, minivans, crossover vehicles, trailers, and boats. When the box is collapsed, it can be stored within the floor or sidewall. The box may form a rectangular prism shape when uncollapsed.

The box may further comprising a bottom tray disposed between the housing and the side walls and hingedly attached to the housing adjacent the lower edge. The bottom tray is pivotable between a position substantially parallel to the housing and a position substantially perpendicular to the housing. Also, the box may further comprise bracing means for stabilizing the bottom tray and/or bracing means for stiffening the side walls when the box is in the uncollapsed configuration. Means for locking the box may also be provided. The box also may further comprise sealing means for making the box substantially dust- and water-tight when in the uncollapsed configuration. The sealing means may sealing means may comprise elastomeric seals. The box cover may comprise at least two sections hingedly joined to each other, and in this case, the box may also comprise means for retaining the two cover sections adjacent each other.

Another embodiment of the present invention comprises a vehicle having a floor and a storage well formed into the floor. The vehicle comprises first and second floor plates hingedly attached to the vehicle floor, with each plate independently pivotable between a closed position where the plate is substantially coplanar with the vehicle floor and partially encloses the storage well and an open position providing access to the storage well. The vehicle also comprises a collapsible storage box mounted to the first floor plate and adjustable between a collapsed configuration within the storage well and an uncollapsed configuration with the box positioned above the vehicle floor and resting upon the second floor plate. The storage box comprises a housing secured to the first floor plate. The housing has a wall, two side extensions and a top extension joined to and extending from the wall, and a lower edge. The box also comprises hinged, foldable side walls with hinges joining the side walls to the side edges of the housing, the side walls being foldable and unfoldable relative to each other and relative to the housing by rotation at the hinges. In addition, the box comprises a rear wall hingedly joined to the side walls and a cover hingedly joined to the top extension of the housing. The box is adjustable between a collapsed configuration with the bottom, the side walls, and the cover pivoted into positions substantially parallel to the first floor plate and within the storage well an uncollapsed configuration with the cover and the side walls substantially perpendicular to the first floor plate and the rear wall substantially parallel to the housing and the first floor plate, with the rear wall supported by the second floor plate. The cover is pivotable between a collapsed configuration with the cover adjacent to and substantially parallel to the housing wall and an open configuration providing access to an interior space within the box. The vehicle may be selected from pickup trucks, sports utility vehicles, minivans, crossover vehicles, cars, trailers, and boats.

The box may further comprise a bottom tray disposed between the housing and the side walls and hingedly attached to the housing adjacent the lower edge. If present, the bottom tray is pivotable between a position substantially parallel to the housing and substantially perpendicular to the housing.

The vehicle may further comprise a drain adjacent to the storage well. The vehicle also may further comprising bracing means for stiffening the side walls and/or comprising means for locking the box when the box is in an uncollapsed configuration. The box may further comprise sealing means for making the box substantially dust- and water-tight when the box is uncollapsed. The sealing means may comprise elastomeric seals. The box may form a rectangular prism shape when uncollapsed. Also, the cover may comprises at least two sections hingedly joined to each other, preferably with means for retaining the two cover sections adjacent each other.

Yet another embodiment of the present invention comprises a vehicle including a floor and a storage well formed into a sidewall of the vehicle. The vehicle comprises a collapsible storage box mounted into the vehicle inside the storage well, with the box adjustable between a collapsed configuration within the storage well and an uncollapsed configuration with the box positioned above the vehicle floor. The storage box comprises a housing secured to the vehicle sidewall. The housing has a wall and a lower edge, with two side extensions and a top extension joined to and extending from the wall. The box also comprises hinged, foldable side walls with hinges joining the side walls to the side edges of the housing, the side walls being foldable and unfoldable relative to each other and relative to the housing by rotation at the hinges. In addition, the box comprises a rear wall hingedly joined to the side walls and a cover hingedly joined to the top extension of the housing. The box is adjustable between a collapsed configuration with the bottom, the side walls, and the cover pivoted into positions substantially parallel to the side wall and within the storage well and an uncollapsed configuration with the cover, the side walls, and the rear wall substantially perpendicular to the housing wall. The cover is pivotable between a collapsed configuration with the cover adjacent to and substantially parallel to the housing wall and an open configuration providing access to an interior space within the uncollapsed box.

The vehicle storage box may further comprise a bottom tray disposed between the housing and the side walls and hingedly attached to the housing adjacent the lower edge, the bottom pivotable between a position substantially parallel to the housing and substantially perpendicular to the housing. The vehicle may be a pickup truck, sports utility vehicle, minivan, crossover vehicle, car, trailer, or boat. There may be a drain adjacent to the storage well.

### BRIEF DESCRIPTION OF THE DRAWINGS

These and other features, aspects, and advantages of the present invention will become better understood with reference to the following description, appended claims, and accompanying drawings, where:

FIG. 1 is a perspective view of a pickup truck bed modified in accordance with the present invention;

FIG. 2 is a cross sectional view of the pickup truck bed of FIG. 1 along A-A;

FIG. 3 is a partially cutaway view of the pickup truck bed of FIG. 1 showing a tool/utility box in accordance with the present invention in a collapsed configuration;

FIG. 4 is a partially cutaway view of the pickup truck bed of FIG. 1 showing the tool/utility box in a partially uncollapsed configuration;

FIG. 5 is a side cutaway view of the housing and lid of the box of FIG. 3;

FIG. 6 is a bottom perspective view of the cover of the box of FIG. 3;

FIG. 7 is a partially cutaway view of the pickup truck bed of FIG. 1 showing the tool/utility box in an uncollapsed configuration, ready for use to store items;

FIG. 8 is a top view of the tool/utility box of FIG. 7 with the cover removed;

FIG. 9 is a cross sectional view of one side of the tool/utility box of FIG. 7 showing a stabilizing mechanism in an engaged configuration;

FIG. 10 is a cross sectional view of the side of the box of FIG. 7 stablizing mechanism of FIG. 9 in a disengaged configuration;

FIG. 11 is a cross sectional view of the stablizing mechanism of FIG. 9 along plane B-B;

FIG. 12 is a detailed top perspective view of the sides of the tool/utility box of FIG. 7;

FIG. 13 is a detailed top perspective view of a side and rear wall of the tool/utility box of FIG. 7;

FIG. 14 is a top perspective view of the tool/utility box of FIG. 7 without the cover;

FIG. 15 is a detailed side view of the housing, tray, and cover of the tool/utility box of FIG. 7;

FIG. 16 is a perspective view of the tray of the tool/utility box of FIG. 7;

FIG. 17 is a perspective view of the side and rear walls of the tool/utility box of FIG. 7;

FIG. 18 is a top view of the tool/utility box of FIG. 7 without the cover;

FIG. 19 is a side perspective view of the housing of the tool/utility box of FIG. 7;

FIG. 20 is a perspective view of another embodiment of a tool/utility box in accordance with the present invention;

FIG. 21 is a perspective view of the open cover of the tool/utility box of FIG. 20;

FIG. 22 is a partially cut away side view of another embodiment of a tool/utility box in accordance with the present invention with the box in an uncollapsed configuration; and

FIG. 23 is a partially cut away side view of the tool/utility box of FIG. 22 in a collapsed configuration.

### DESCRIPTION OF THE PREFERRED EMBODIMENTS

The present invention comprises a collapsible box suitable for use as a tool box or utility container mounted into the bed or sidewall of a pickup truck, sport utility vehicle, minivan, or crossover vehicle, or into the trunk or other cargo space of a car or other vehicle. Preferably, the collapsed box is relatively thin, perhaps about 2 inches thick. In the following description, references to orientation in space, such as horizontal, vertical, top, bottom, or sides are intended to describe the box in its normal configuration during use. The terms “front” and “rear” are used relative to the front and rear of the vehicle. It should be understood that the box could be rotated and used in other orientations.

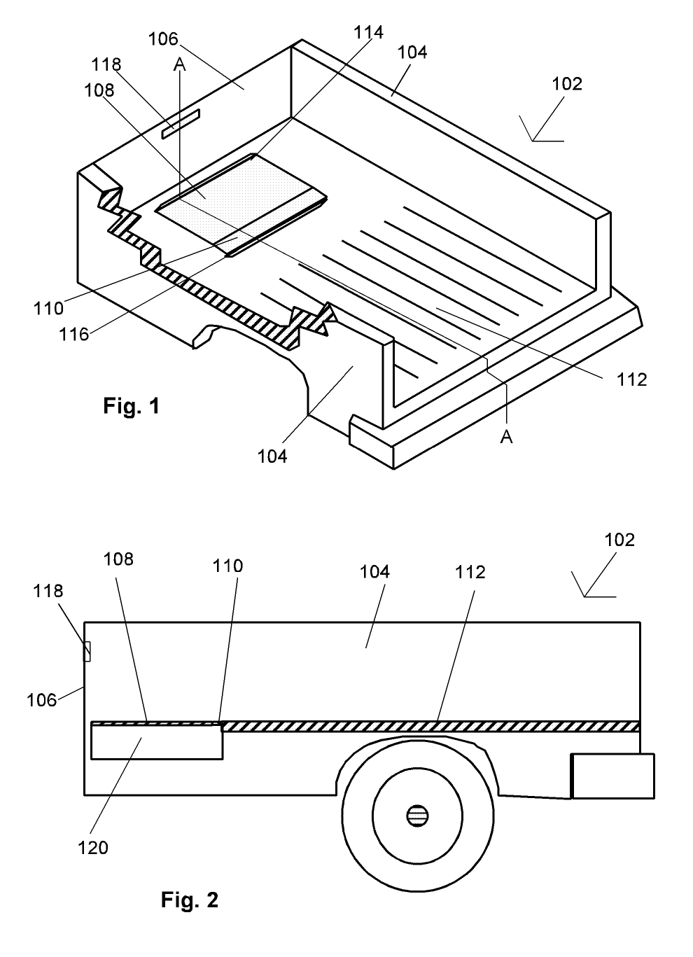

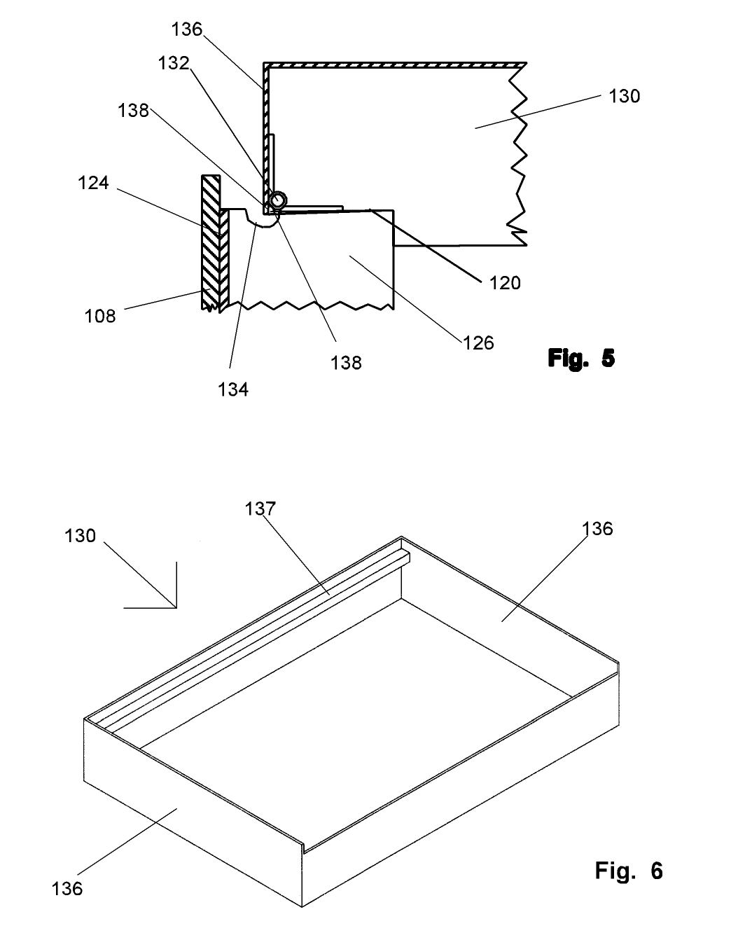

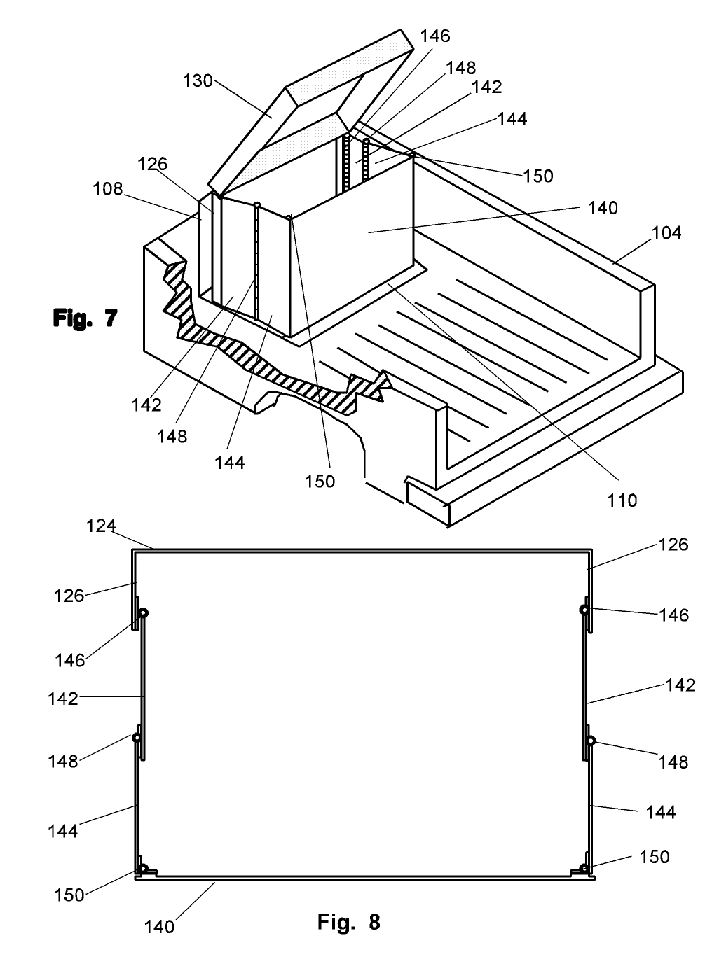

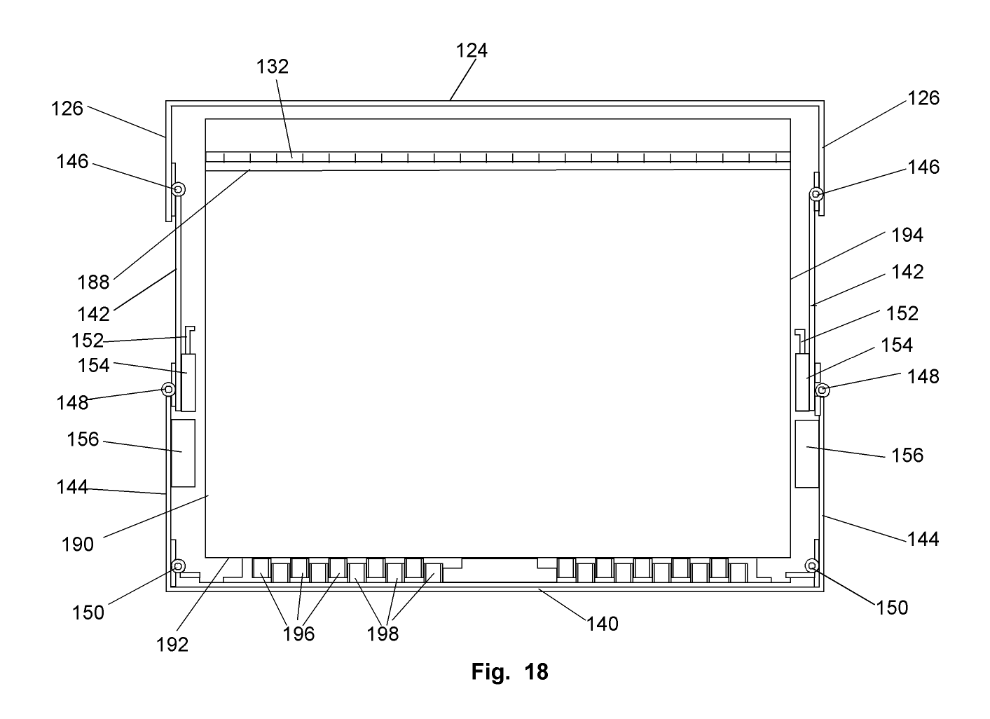

One embodiment of the present invention may be understood with reference to FIGS. 1-18. FIG. 1 shows the back 102 of a pickup truck with part of one side wall 104 cut away. Note that a pickup truck is shown as an example of a vehicle into which the box is mounted, but it could also be another type of vehicle, such as a sport utility vehicle, minivan, crossover vehicle, car, trailer, or boat. Near the front wall 106, two floor plates 108 and 110 lie substantially coplanar with the pickup truck floor 112. Hinge 114 pivotably attaches plate 108 to the floor 112 along the edge closest to the front of the truck, and hinge 116 pivotably attaches plate 110 to the floor 112 along the edge closest to the rear of the truck. Bumper 118 is formed from a somewhat resilient material and braces and stabilizes floor plate 108 when it is rotated upward as described below. As shown in vertical cross section FIG. 2, plates 108 and 110 cover a well 120 recessed into the bed 102 of the pickup truck and into which a folded or collapsed utility box 122 fits.

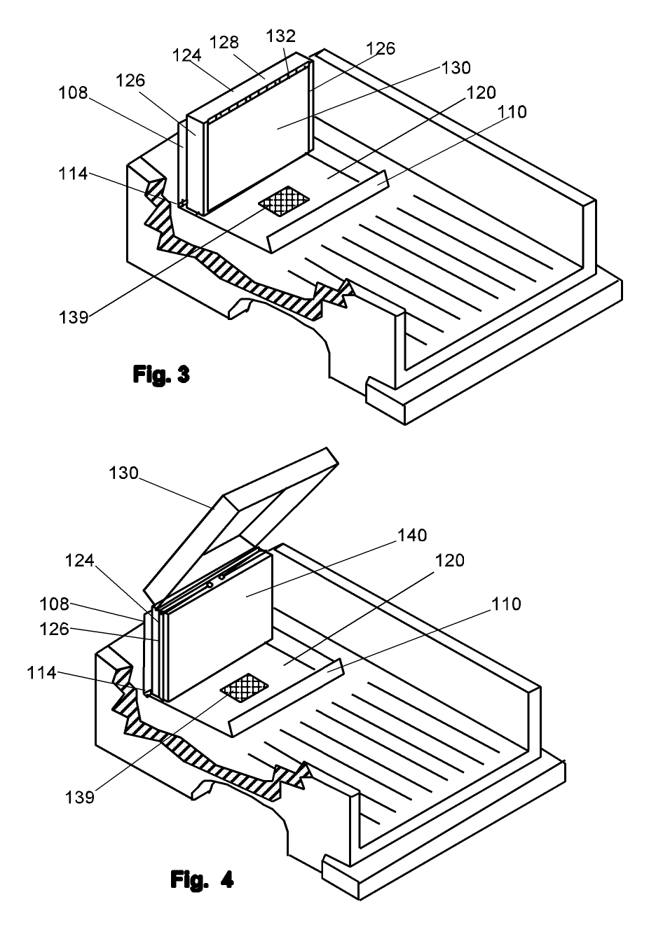

Referring to FIG. 3, plates 108 and 110 can be released and lifted by a mechanism (not shown) that causes the plates to rotate upwards about the hinges 114 and 116, respectively. Any mechanism known in the art could be used, and preferred mechanisms include mechanical and electrical spring-loaded devices that are activated from inside the cab of the truck or from the front seat of a vehicle. Plate 108 is attached to housing 124 of utility box 122. Housing side extensions 126 and a 128 partially enclose cover 130 of the utility box. As shown in FIGS. 4-7, cover 130 is joined to top extension 128 via hinge 132 and is pivotable about hinge 132 to expose rear wall 140 of the box. Hinges 146 join side wall portions 142 to housing 124, hinges 148 join side wall portions 142 and 144 to each other, and hinges 150 join side wall portions 144 to rear wall 140. To uncollapse box 122, rear floor plate 10 can be rotated back to into a position substantially coplanar with pickup truck floor 112, and rear wall 140 can be pulled rearward until it rests on rear floor plate 110. Plate 110, when rotated about hinge 116 back to its horizontal position in the plane of the truck bed 112, provides a support for rear wall 140 when side wall portions 142 and 144 are unfolded. A stop bar 137, seen in FIG. 6, may be mounted to the interior surface of cover 130 and rests on the upper edge of rear wall 140 when the lid is in the closed position over box 122.

As shown in FIG. 4, groove 134 extends across the housing top extension 128 from left to right adjacent hinge 132 to channel water away from the box contents when the box is in the uncollapsed position. Side extensions 136 extend downward from the flat surface of the housing top past hinge 132 to divert water from the storage area. Elastomeric seal 138 also aids in keeping water out of the storage area. The bottom of well 120 optionally includes a drain 139 to provide drainage for water underneath the box 120.

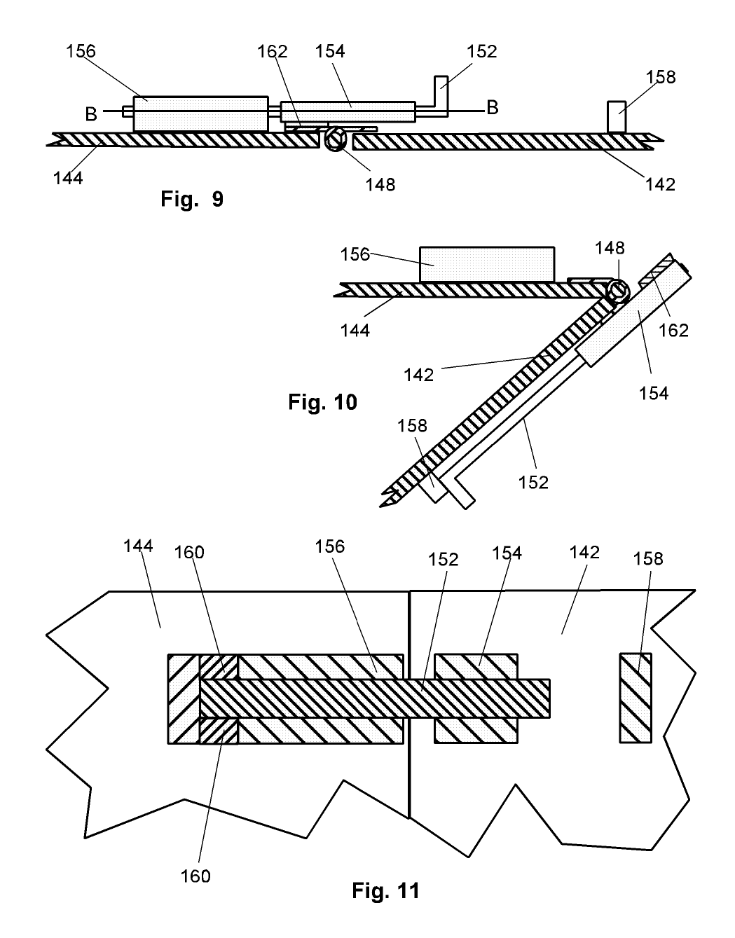

Referring to FIGS. 9-11, side wall portions 142 and 144 are preferably stabilized in the uncollapsed position, such as with sliding bolt 152, when the box is in the unfolded configuration. Bolt 152 is slideable within bolt holders 154 and 156, mounted to side wall portions 142 and 144, respectively. Stop 158 limits the travel of bolt 152 out of the holder 154. A magnet 160 within bolt holder 156 retains bolt 152 in position when the box is in the unfolded configuration. Optional seal 162 prevents water from leaking into the box when it is uncollapsed, as in FIG. 8.

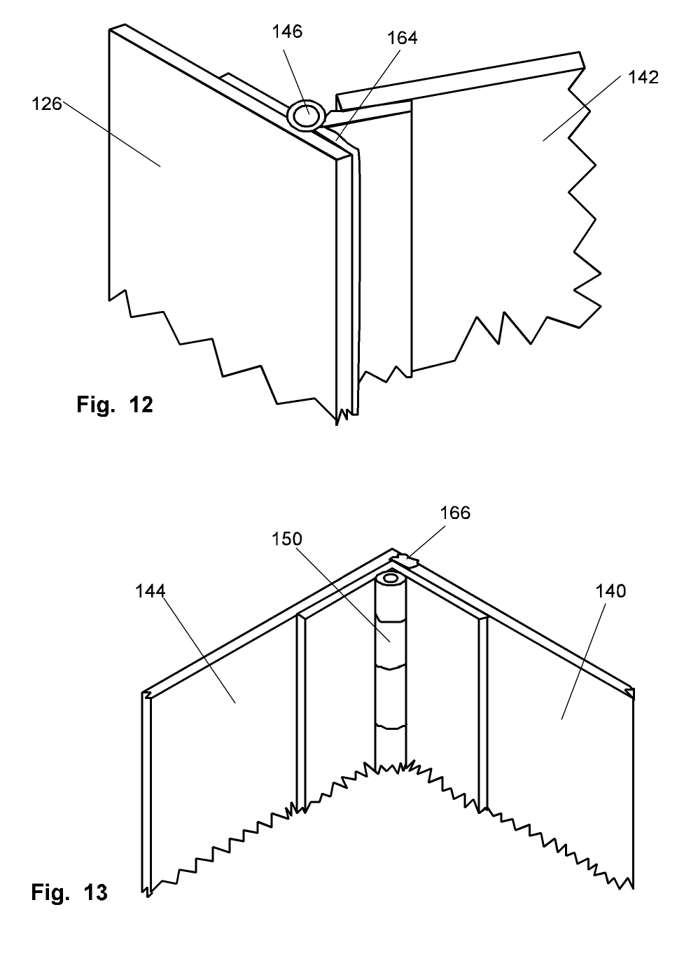

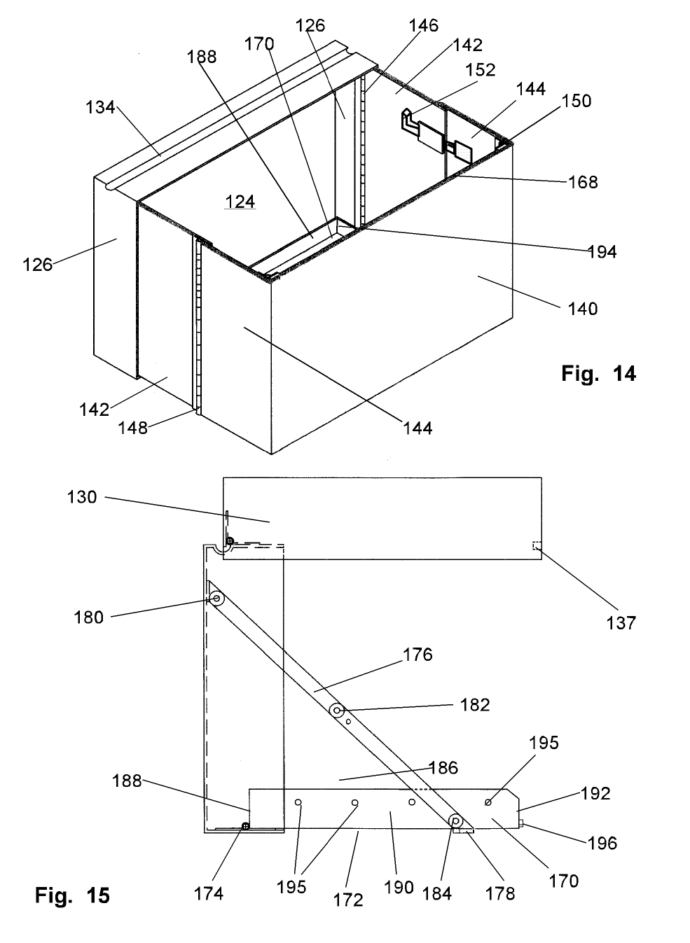

If the box 122 is installed in the back of a pickup truck, where it will potentially be exposed to dust, rain, snow, and other weather conditions, as well as insects and spiders, it is desirable to provide seals where the sides and cover of the box are joined to each other. As shown in FIGS. 9 and 10, elastomeric seals or gaskets 162 are positioned adjacent the hinges 148 joining housing side wall portions 142 to side wall portions 144. Referring to FIG. 12, seals 164 are positioned adjacent hinges 146 joining housing side extensions 126 to side wall portions 142. Elastomeric seals or gaskets 166 are positioned adjacent the hinges 150 joining side portions 144 to rear wall 140, as shown in FIG. 13. Seal or gasket 168 may be provided along the top edges of side wall portions 142 and 144 and along the top edge of rear wall 140, as shown in FIG. 14. An additional seal or gasket (not shown) may be provided on the interior surface of the cover 130. These seals or gasket are particularly desirable if the box will be subjected to water and dust, such as if it is mounted into a pickup truck bed.

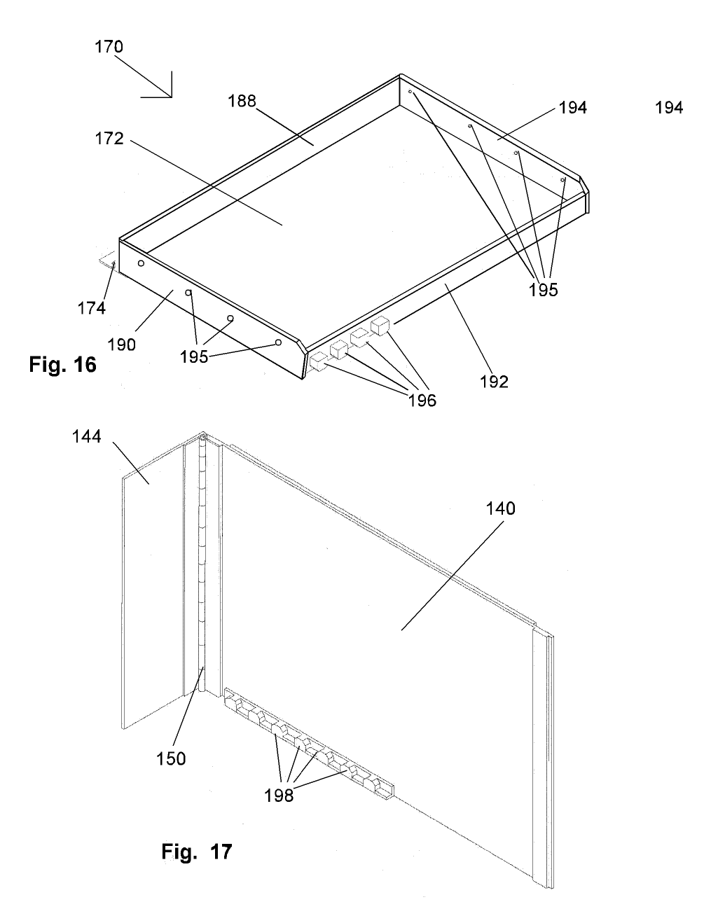

Box 122 also optionally includes a tray 170 that can be positioned as a box bottom, which is particularly desirable if the box is installed in a pickup truck or other vehicle where it will be exposed to weather conditions and/or water, as shown in FIGS. 15 and 16. The tray bottom 172 is joined to side extensions 126 of housing 124 via hinge 174. Braces 176 and plate 178 support tray 170 when the box is unfolded for use. Braces 176 are pivotable at hinges 180, 182, and 184 to collapse or uncollapse the box, and mating notches 186 near hinge 182 stabilize the braces 176 when the box is uncollapsed. Bottom tray 170 also has side walls 188, 190, 192, and 194 that extend from the tray bottom 172, oriented upward when the box is in use. Holes 195 in side walls 190 and 194 may be used to tie items down that are carried within box 122.

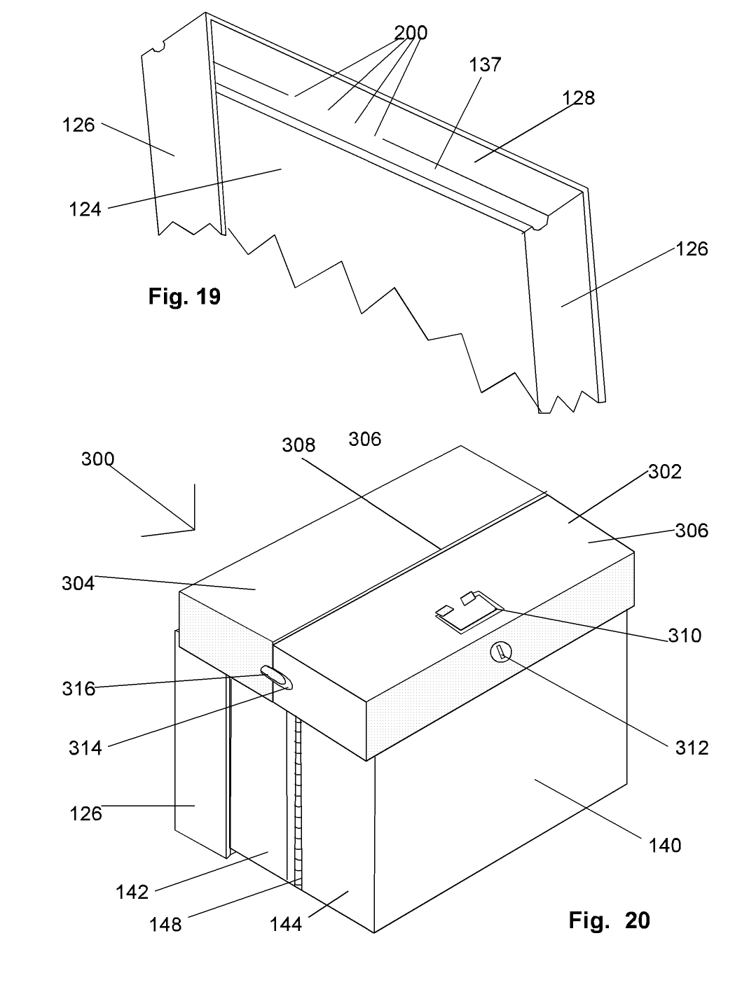

Referring to FIGS. 15-18, bottom tray 170 preferably includes alignment tabs 196 that extend outward from the rear side wall 192. The interior surface of rear wall 140 includes a series of grooves or alignment features 198 that are matable with tabs 196 to prevent sideways motion of the tray when box 122 is in the uncollapsed configuration. Referring to FIG. 19, housing 124 may also include a series of alignment features 200 that are matable with tabs 196 when the tray 170 is folded against housing 124 for storage, thereby stabilizing tray 170 against sideways motion.

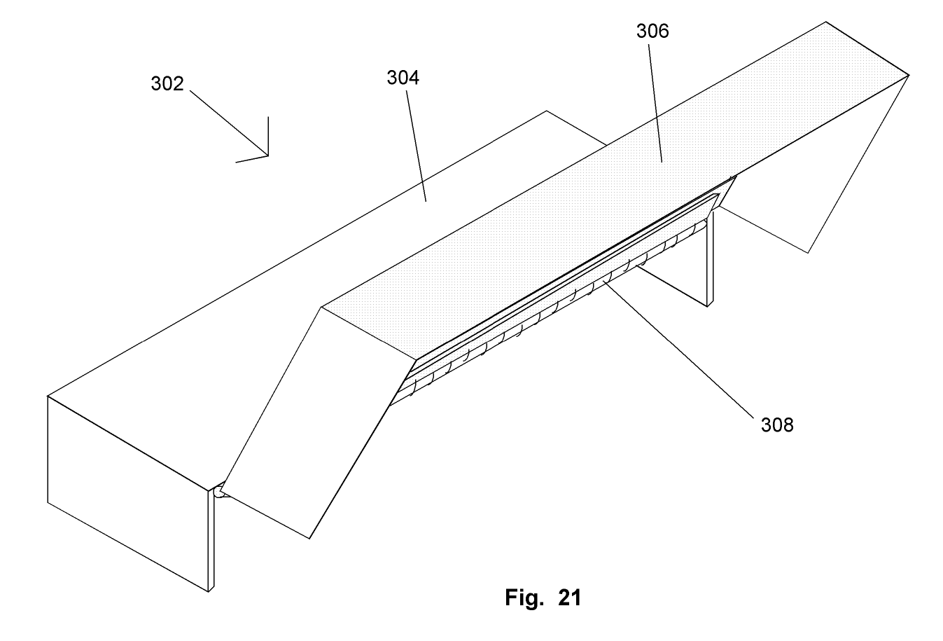

Another embodiment 300 of the utility box of the present invention is shown in FIGS. 20-21. Box 300 has a cover 302 comprising front cover portion 304 joined to rear cover portion 306 at hinge 308. Splitting the cover into two portions allows the box to be opened in an environment where space is limited, such as inside a sport utility vehicle, minivan, “crossover” vehicle, or station wagon, or in a car trunk. Swing up handle 310 and lock 312 are attached to rear cover portion 306, and a magnet (not shown) may be mounted to rear cover portion 306 to retain the handle 310 against the cover when the handle is not in use. Although lock 312 is a keyed lock, other types of locking mechanisms could be used, such as hasps combined with a padlock or locking cable, electronic locks, or combination locks. A striker 314 and a latch 316, similar to those used on footlockers and other storage boxes, may be used to provide rigidity to the cover 402. Other features of box 300 are the same as those in box 122.

A box in accordance with the present invention can have dimensions suitable for storing various types of cargo. Indeed, the box may be sized to fit between the wheel wells of most truck models or along the side of a truck bed adjacent one wheel well for easy access. Alternatively, the box could be carried inside a vehicle or in a vehicle trunk.

In use, the tool/utility box in accordance with the present invention can be opened as shown in FIGS. 1, 3, 4, and 7. Floor plates 108 and 110 are rotated upwards along hinges 114 and 116, respectively, to expose housing 124. Lid 130 is rotated away from housing along hinge 132 to an open position. Floor plate 110 is returned to its position in the vehicle floor, and side walls 142 and 144 are extended until they are substantially coplanar and rear wall 140 rests upon floor plate 110. Bolts 152 are engaged into bolt holders 156 to stabilize the side walls 142 and 144. If present, tray 170 is rotated about hinge 174 until mating notches 186 of braces 176 are engaged with each other and, if present, alignment tabs 196 are engaged with alignment features 198. Items to be stored may the be placed inside box 122, and lid 130 or 302 can be closed and locked in place, if desired, via lock 312 and/or via latch 316 and striker 314. To collapse the box, the process is reversed.

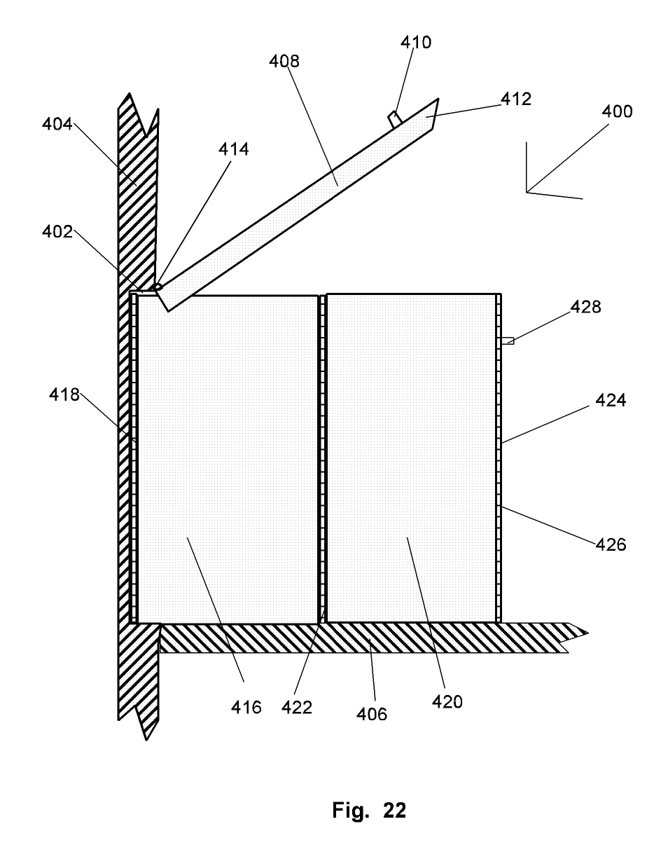

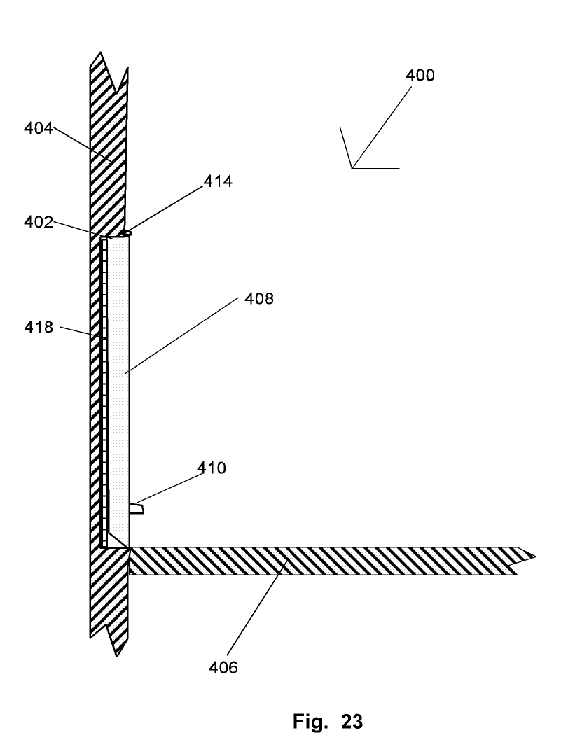

Referring to FIGS. 22 and 23, another embodiment 400 of a box in accordance with the present invention may be mounted into a well 402 within a sidewall 404 or other vertical wall within a vehicle, preferably adjacent the floor 406. Cover 408 is provided with a handle 410 and side extensions 412, and it is joined to the vehicle side wall 404 with a hinge 414. Side wall portions 416 are joined to vehicle side wall 404 via hinges 418 inside well 406 and also joined to side wall portions 420 via hinges 422. Rear wall 424 is joined to side wall portions 420 via hinges 426 and may include a handle 428. The lower edges of side wall portions 416, 420 and rear wall 424 may rest upon the upper surface of floor 406. Box 400 may include a bottom tray (not shown) similar to bottom tray 170 in FIGS. 14-16. When box 400 is collapsed, cover 408 fits over and around the folded side wall portions 416 and 420 and rear wall 424, as shown in FIG. 23.

The box in accordance with the present invention can be formed from any material or materials with suitable stiffness and durability to function as intended. For example, the cover, sides, and walls of the box could be formed from sheet metal, or they could be formed from plastic, such as by injection molding. As shown hinges 114, 116, 132, 146, 148, 150, 174, 414, 418, 422, and 424 are piano type hinges, although any type of hinge or hinges could be used between the sections, as long as the box is easily foldable and unfoldable, and, preferably, as long as the box can be made water- and dust-tight if it is to be exposed to the elements.

It should be noted that, depending upon the desired dimensions of the box, there could be additional hinged wall sections. Also, the walls, cover, and bottom could form a shape other than a rectangular prism. For example, the box could have a shape that substantially fills the cargo area in a vehicle and conforms to wheel wells that protrude into the cargo space.

The foregoing description is considered as illustrative only of the principles of the invention. Further, since numerous modifications and changes will readily occur to those skilled in the art, it is not desired to limit the invention to the exact construction and process shown and described above. Accordingly, all suitable modifications and equivalents may be resorted to falling within the scope of the invention.

I claim:

1. A collapsible storage box comprising:
a housing having a wall, with two side extensions and a top extension joined to and extending from said wall, and a lower edge;
two hinged, foldable side walls with hinges joining each of said side walls to said side edges of said housing, said side walls being foldable and unfoldable relative to each other and relative to said housing by rotation at said hinges;
a rear wall hingedly joined to said side walls; and
a cover hingedly joined to said top extension of said housing said cover pivotable between a collapsed configuration with said cover adjacent to and substantially parallel to said housing wall and an open configuration providing access to an interior space within said box;
wherein said box is adjustable between a collapsed configuration with said bottom, said side walls, and said cover pivoted into positions substantially parallel to said planar wall of said housing and an uncollapsed configuration with said bottom and said top substantially perpendicular to said housing wall and with said side walls substantially perpendicular to said bottom and said cover; and
wherein said housing is integral with a portion of a vehicle cargo area, the portion selected from floor portions and sidewall portions, and said box, when collapsed, can be stored within the floor or sidewall portion.

2. The collapsible box of claim 1, further comprising a bottom tray disposed between said housing and said side walls and hingedly attached to said housing adjacent said lower edge, said bottom tray pivotable between a position substantially parallel to said housing and substantially perpendicular to said housing.

3. The box of claim 2, further comprising bracing means for stabilizing said bottom tray when said box is in said uncollapsed configuration.

4. The box of claim 1, further comprising bracing means for stiffening said side walls when said box is in said uncollapsed configuration.

5. The box of claim 1, further comprising means for locking said box.

6. The box of claim 1, wherein said box further comprises sealing means for making said box substantially dust- and water-tight when in said uncollapsed configuration.

7. The box of claim 6, wherein said sealing means comprises elastomeric seals.

8. The box of claim 1, wherein said box forms a rectangular prism shape when uncollapsed.

9. The box of claim 8, wherein said cover comprises at least two sections hingedly joined to each other.

10. The box of claim 9, further comprising means for retaining said two cover sections adjacent each other.

11. The box of claim 1, wherein said vehicle cargo area is in a vehicle selected from pickup trucks, sports utility vehicles, minivans, crossover vehicles, trailers, and boats.

12. A vehicle including floor and a storage well formed into the floor of said vehicle, said vehicle comprising:
first and second floor plates hingedly attached to said vehicle floor, with each plate independently pivotable between a closed position where said plate is substantially coplanar with said vehicle floor and partially encloses the storage well and an open position providing access to the storage well; and
a collapsible storage box mounted to said first floor plate and adjustable between a collapsed configuration within the storage well and an uncollapsed configuration with said box positioned above said vehicle floor and resting upon said second floor plate, said storage box comprising:
a housing secured to said first floor plate, said housing having a wall, two side extensions and a top extension joined to and extending from said wall, and a lower edge;
hinged, foldable side walls with hinges joining said side walls to said side edges of said housing, said side walls being foldable and unfoldable relative to each other and relative to said housing by rotation at said hinges;
a rear wall hingedly joined to said side walls; and
a cover hingedly joined to said top extension of said housing said cover pivotable between a collapsed configuration with said cover adjacent to and substantially parallel to said housing wall and an open configuration providing access to an interior space within said box;
wherein said box is adjustable between a collapsed configuration with said bottom, said side walls, and said cover pivoted into positions substantially parallel to said first floor plate and within the storage well an uncollapsed configuration with said cover and said side walls substantially perpendicular to said first floor plate and said rear wall substantially parallel to said housing and said first floor plate, with said rear wall supported by said second floor plate.

13. The vehicle of claim 12, wherein said storage box further comprises a bottom tray disposed between said housing and said side walls and hingedly attached to said housing adjacent said lower edge, said bottom tray pivotable between a position substantially parallel to said housing and substantially perpendicular to said housing.

14. The vehicle of claim 12, wherein said vehicle further comprises a drain adjacent to the storage well.

15. The vehicle of claim 12, further comprising bracing means for stiffening said side walls when said box is in said uncollapsed configuration.

16. The vehicle of claim 12, further comprising means for locking said box.

17. The vehicle of claim 12, wherein said box further comprises sealing means for making said box substantially dust- and water-tight when in said uncollapsed configuration.

18. The vehicle of claim 17, wherein said sealing means comprises elastomeric seals.

19. The vehicle of claim 12, wherein said box forms a rectangular prism shape when uncollapsed.

20. The vehicle of claim 12, wherein said cover comprises at least two sections hingedly joined to each other.

21. The vehicle of claim 20, further comprising means for retaining said two cover sections adjacent each other.

22. The vehicle of claim 12, wherein said vehicle is selected from pickup trucks, sports utility vehicles, minivans, crossover vehicles, trailers, and boats.

23. A vehicle including floor and a storage well formed into a sidewall of said vehicle, said vehicle comprising:
a collapsible storage box mounted into said vehicle inside the storage well, said box adjustable between a collapsed configuration within the storage well and an uncollapsed configuration with said box positioned above said vehicle floor, said storage box comprising:
a housing secured to said vehicle sidewall, said housing having a wall, two side extensions and a top extension joined to and extending from said wall, and a lower edge;
hinged, foldable side walls with hinges joining said side walls to said side edges of said housing, said side walls being foldable and unfoldable relative to each other and relative to said housing by rotation at said hinges;
a rear wall hingedly joined to said side walls; and
a cover hingedly joined to said top extension of said housing said cover pivotable between a collapsed configuration with said cover adjacent to and substantially parallel to said housing wall and an open configuration providing access to an interior space within said box;
wherein said box is adjustable between a collapsed configuration with said bottom tray, said side walls, and said cover pivoted into positions substantially parallel to said side wall and within the storage well and an uncollapsed configuration with said cover, said side walls, and said rear wall substantially perpendicular to said housing wall.

24. The vehicle of claim 23, wherein said storage box further comprises a bottom tray disposed between said housing and said side walls and hingedly attached to said housing adjacent said lower edge, said bottom pivotable between a position substantially parallel to said housing and substantially perpendicular to said housing.

25. The vehicle of claim 23, wherein said vehicle further comprises a drain adjacent to the storage well.

26. The vehicle of claim 23, wherein said vehicle is selected from pickup trucks, sports utility vehicles, minivans, crossover vehicles, trailers, and boats.
